(19) United States
(12) Patent Application Publication
(10) Pub. No.: US 2022/0350192 A1
(43) Pub. Date: Nov. 3, 2022

(54) DISPLAY DEVICE AND MANUFACTURING METHOD THEREOF

(71) Applicant: WUHAN CHINA STAR OPTOELECTRONICS SEMICONDUCTOR DISPLAY TECHNOLOGY CO., LTD., Wuhan, Hubei (CN)

(72) Inventor: Jianlong HUANG, Wuhan, Hubei (CN)

(21) Appl. No.: 17/057,666

(22) PCT Filed: Sep. 15, 2020
(86) PCT No.: PCT/CN2020/115216

§ 371 Date: Nov. 22, 2020

(30) Foreign Application Priority Data
Jun. 28, 2020 (CN) 202010596963.8

(51) Int. Cl. G02F 1/1335

(52) U.S. Cl. CPC G02F 1/133512; G02F 1/133516

(57) ABSTRACT

A display device is provided. The display device includes a substrate, a light-shielding layer, and a color filter layer. An upper surface of the substrate is provided with a concave-convex structure, the light-shielding layer is disposed on the substrate, and the color filter layer is disposed on the light-shielding layer.

### BACKGROUND OF INVENTION

### Field of Invention

The present application relates to a display technology field, and more particularly, to a display device and a manufacturing method thereof.

### Description of Prior Art

Currently, in liquid crystal panels, there is poor wettability between a light-shielding layer and a substrate, causing the light-shielding layer to peel off from the substrate. Therefore, liquid crystal leakage is prone to occur when the liquid crystal panels are driven or when reliability tests are performed on the liquid crystal panels, which leads to failure of the reliability tests, reducing yields of display devices and increasing production costs. Therefore, performance of the display panels is affected.

The present application provides a display device and a manufacturing method thereof to improve performance of the display device.

### SUMMARY

The present application provides a display device, comprising:

a substrate, wherein an upper surface of the substrate is provided with a concavo-convex;

a light-shielding layer disposed on the substrate;

a color filter layer disposed on the light-shielding layer; and

an array substrate disposed on the color filter layer.

In the display device provided by the present application, a thickness of the concavo-convex accounts for 5% to 20% of a total thickness of the substrate.

In the display device provided by the present application, a thickness of the substrate ranges from 1000 nanometers to 500000 nanometers.

In the display device provided by the present application, a thickness of the light-shielding layer ranges from 100 nanometers to 1200 nanometers.

In the display device provided by the present application, a roughness of the concave-convex structure ranges from 0.5 micrometer to 6 micrometer.

In the display device provided by the present application, an area of the concavo-convex accounts for 0.5% to 6% of a total area of the substrate.

In the display device provided by the present application, the display device further comprises a liquid crystal layer, and the liquid crystal layer is disposed between the color filter layer and the array substrate.

In the display device provided by the present application, the display device further comprises a first conductive layer, and the first conductive layer is located at a side of the liquid crystal layer away from the array substrate.

In the display device provided by the present application, the display device further comprises a second conductive layer, and the second conductive layer is located at a side of the liquid crystal layer close to the array substrate.

The present application further provides a display deice, comprising:

a substrate, wherein an upper surface of which is provided with a concavo-convex;

a light-shielding layer disposed on the substrate; and

a color filter layer disposed on the light-shielding layer.

In the display device provided by the present application, a thickness of the concavo-convex accounts for 5% to 20% of a total thickness of the substrate.

In the display device provided by the present application, a thickness of the substrate ranges from 1000 nanometers to 500000 nanometers.

In the display device provided by the present application, a thickness of the light-shielding layer ranges from 100 nanometers to 1200 nanometers.

In the display device provided by the present application, a roughness of the concave-convex structure ranges from 0.5 micrometer to 6 micrometer.

In the display device provided by the present application, an area of the concavo-convex accounts for 0.5% to 6% of a total area of the substrate.

The present application further provides a method for manufacturing a display device, comprising steps of:

providing a substrate;

forming a concave-convex structure on an upper surface of the substrate by processing the substrate;

forming a light-shielding layer on the substrate; and

forming a color filter layer on the light-shielding layer.

In the method for manufacturing the display device provided by the present application, the step of forming the concave-convex structure on the upper surface of the substrate by processing the substrate comprises:

polishing the substrate to form the concave-convex structure on the upper surface of the substrate.

In the method for manufacturing the display device provided by the present application, the step of forming the concave-convex structure on the upper surface of the substrate by processing the substrate comprises:

etching the substrate to form the concave-convex structure on the upper surface of the substrate.

In the method for manufacturing the display device provided by the present application, energy used in the polishing ranges from 4000 millijoules per square centimeter to 8000 millijoules per square centimeter.

The present application provides a display device and a manufacturing method thereof. The display device includes a substrate, a light-shielding layer, and a color filter layer. An upper surface of the substrate is provided with a concave-convex structure, the light-shielding layer is disposed on the substrate, and the color filter layer is disposed on the light-shielding layer. In the present application, by providing the concave-convex structure on the substrate, the concave-convex structure is covered by the light-shielding layer, thereby increasing a contact area between the light-shielding layer and the substrate to improve wettability between the light-shielding layer and the substrate, and preventing the light-shielding layer from peeling off. Therefore, performance of the display device is improved.

### DESCRIPTION OF DRAWINGS

In order to clearly illustrate embodiments or technical solutions of the present application, brief descriptions of drawings used in the embodiments would be given as below. Obviously, the drawings described below are merely some embodiments of the present application. For persons skilled in this art, other drawings can be obtained from these drawings under the premise of no creative efforts made.

FIG. 1 is a cross-sectional view of a first structure of a display device in accordance with the present application.

FIG. 2 is a top view of a display device in accordance with the present application.

FIG. 3 is a cross-sectional view of a second structure of a display device in accordance with the present application.

FIG. 4 is a cross-sectional view of a third structure of a display device in accordance with the present application.

FIG. 5 is a flowchart of a method for manufacturing a display device in accordance with the present application.

### DETAILED DESCRIPTION OF EMBODIMENTS

Technical solutions in embodiments of the present application will be described clearly and completely in conjunction with accompanying drawings of the embodiments of the present application. Obviously, the described embodiments are only parts of embodiments of the present application, they are not all the embodiments. Based on the embodiments of the present application, other embodiments obtained by persons skilled in this art under the premise of no creative efforts made fall within the protection scope of the present application.

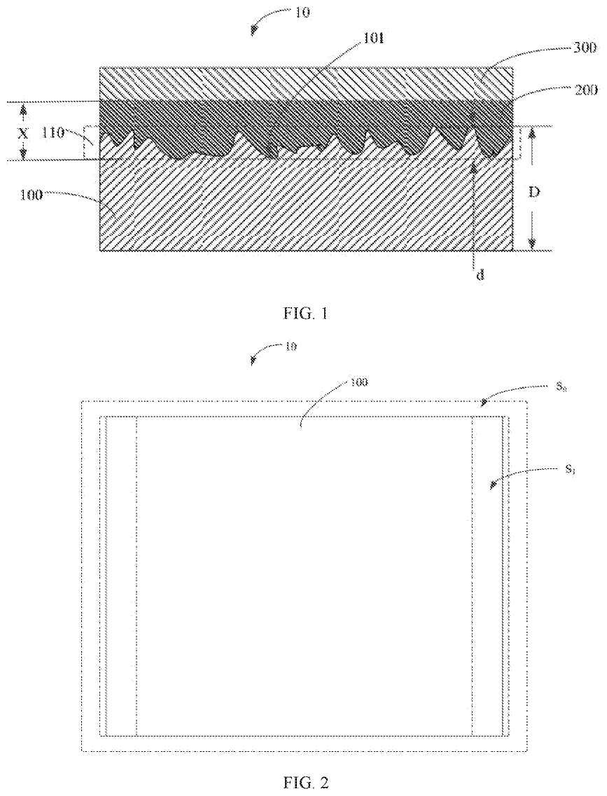

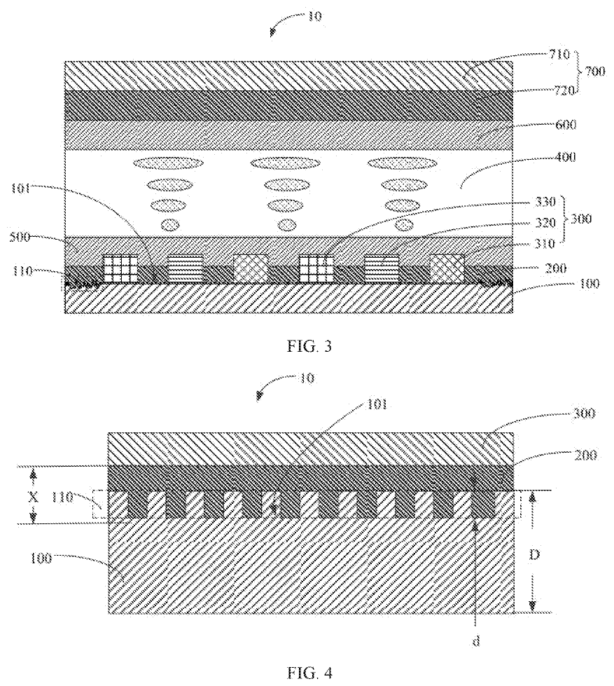

Refer to FIG. 1, FIG. 2, and FIG. 3, FIG. 1 is a cross-sectional view of a first structure of a display device in accordance with the present application, FIG. 2 is a top view of a display device in accordance with the present application, and FIG. 3 is a cross-sectional view of a second structure of a display device in accordance with the present application. The present application provides a display device 10. The display device 10 includes a substrate 100, a light-shielding layer 200, and a color filter layer 300.

An upper surface 101 of the substrate 100 is provided with a concavo-convex 110. The concavo-convex 110 may be shaped as a regular geometric pattern or as an irregular geometric pattern. In the present embodiment, the concavo-convex 110 is an irregular geometric pattern.

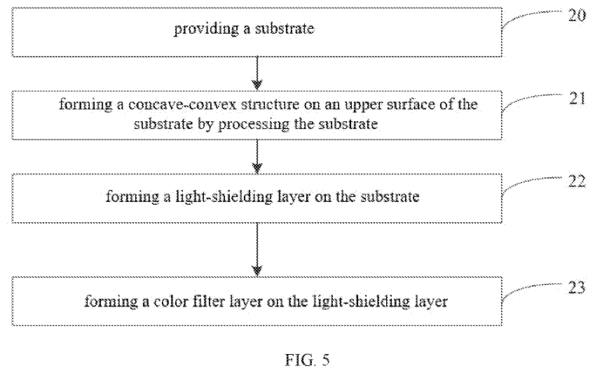

Refer to FIG. 4, which is a cross-sectional view of a third structure of a display device in accordance with the present application. It should be noted that a difference between FIG. 4 and FIG. 1 is that the concave-convex structure 110 is the regular geometric pattern. Other structures are shown in FIG. 1, it will not be repeated here.

In another embodiment, a thickness D of the substrate 100 ranges from 1000 nanometers to 500000 nanometers. Specifically, the thickness D of the substrate 100 may be 2000 nanometers, 100000 nanometers, 200000 nanometers, or 400000 nanometers, etc.

In another embodiment, a roughness of the concave-convex structure 110 ranges from 0.5 micrometer to 6 micrometer. Specifically, the roughness of the concave-convex structure 110 may be 0.8 micrometer, 1 micrometer, 3 micrometer, or 5.2 micrometer, etc.

In another embodiment, a thickness d of the concavo-convex 110 accounts for 5% to 20% of a total thickness D of the substrate. Specifically, the thickness D of the concavo-convex 110 may account for 6%, 10%, 14%, 16%, or 18% of the total thickness D of the substrate.

In another embodiment, an area S₁ of the concave-convex structure 110 accounts for 0.5%-6% of a total area S₀ of the substrate 100. The area S₁ of the concave-convex structure 110 may account for 0.7%, 1.2%, 3%, or 4.6% of the total area S₀ of the substrate 100.

The light-shielding layer 200 is disposed on the substrate 100. Specifically, the light-shielding layer 200 is arranged in an array and disposed on the substrate 100.

In another embodiment, a thickness X of the light-shielding layer 200 ranges from 100 nanometers to 1200 nanometers. Specifically, the thickness X of the light-shielding layer 200 may be 200 nanometers, 400 nanometers, 700 nanometers, or 900 nanometers, etc.

The color filter layer 300 is disposed on the light-shielding layer 200. Specifically, the color filter layer 300 includes a first filter portion 310, a second filter portion 320, and a third filter portion 330. The first filter portion 310, the second filter portion 320, and the third filter portion 330 are disposed between the light-shielding layer 200. The first filter portion 310 is one of a red-light filter portion, a green-light filter portion, or a blue-light filter portion. The second filter portion 320 is one of the red-light filter portion, the green-light filter portion, and the blue-light filter portion. The third filter portion 330 is one of the red-light filter portion, the green-light filter portion, and the blue-light filter portion.

In another embodiment, the display device 10 further includes a liquid crystal layer 400 and an array substrate 700. The array substrate 700 includes a substrate layer 710 and a transistor layer 720. The transistor layer 720 is disposed on the substrate layer 710. The liquid crystal layer 400 is disposed between the array substrate 700 and the color filter layer 300.

In another embodiment, the display device 10 further includes a first conductive layer 500 and a second conductive layer 600. The first conductive layer 500 is located at a side of the liquid crystal layer 400 away from the array substrate 100. The second conductive layer 600 is located at a side of the liquid crystal layer 400 close to the array substrate 100.

The present application provides a display device and a manufacturing method thereof. The display device includes a substrate, a light-shielding layer, and a color filter layer. An upper surface of the substrate is provided with a concave-convex structure, the light-shielding layer is disposed on the substrate, and the color filter layer is disposed on the light-shielding layer. In the present application, by providing the concave-convex structure on the substrate, the concave-convex structure is covered by the light-shielding layer, thereby increasing a contact area between the light-shielding layer and the substrate, improving wettability.

between the light-shielding layer and the substrate and preventing the light-shielding layer from peeling off. Therefore, performance of the display device is improved.

Refer to FIG. 5, which is a flowchart of a method for manufacturing a display device in accordance with the present application. The present application further provides a method for manufacturing a display device, including steps of:

Step 20: providing a substrate 100.

Step 21: forming a concave-convex structure 110 on an upper surface 101 of the substrate 100 by processing the substrate 100.

The concave-convex structure 110 is formed on the upper surface 101 of the substrate 100 through a laser polishing process. When the substrate 100 is subjected to the laser polishing process, the substrate 100 absorbs some photons, chemical bonds of the upper surface of the substrate 100 are broken, and a structure of the upper surface is destroyed, so the concave-convex structure 110 is formed, and a contact area between the light-shielding layer 200 and the substrate 100 is increased. Energy used in the laser polishing process ranges from 4000 millijoules per square centimeter (mJ/cm²) to 8000 mJ/cm². Specifically, the energy used in the laser polishing process is 5000 mJ/cm², 6400 mJ/cm², 7100 mJ/cm², or 7800 mJ/cm².

In another embodiment, the concave-convex structure 110 formed on the substrate 100 may not be formed through the laser polishing process, but may be formed by etching, and etching gas may be hydrofluoric acid.

Step 22: forming a light-shielding layer 200 on the substrate 100.

Specifically, a light-shielding layer material is disposed on the substrate 100, and the light-shielding layer 200 arranged in an array is formed by etching.

Step 23: forming a color filter layer 300 on the light-shielding layer 200.

Specifically, the color filter layer 300 is disposed between the light-shielding layer 200 arranged in the array. The color filter layer 300 includes a first filter portion 310, a second filter portion 320, and a third filter portion 330. The first filter portion 310 is one of a red-light filter portion, a green-light filter portion, or a blue-light filter portion. The second filter portion 320 is one of the red-light filter portion, the green-light filter portion, or the blue-light filter portion. The third filter portion 330 is one of the red-light filter portion, the green-light filter portion, or the blue-light filter portion.

After the step of forming the color filter layer 300 on the light-shielding layer 200, a liquid crystal layer 400 and an array substrate 700 are further formed. The liquid crystal layer 400 is disposed between the array substrate 700 and the color filter layer 300.

The present application provides a display device and a manufacturing method thereof. The display device includes a substrate, a light-shielding layer, and a color filter layer. An upper surface of the substrate is provided with a concave-convex structure, the light-shielding layer is disposed on the substrate, and the color filter layer is disposed on the light-shielding layer. In the present application, by providing the concave-convex structure on the substrate, the concave-convex structure is covered by the light-shielding layer, thereby increasing a contact area between the light-shielding layer and the substrate, improving wettability between the light-shielding layer and the substrate, and preventing the light-shielding layer from peeling off. Therefore, performance of the display device is improved.

A detailed introduction to the embodiments of the present application is given as above. Specific examples are used in this article to describe principles and implementations of the present application, and the above descriptions of the implementations are only used to help understand the present application. Furthermore, for persons skilled in this art, according to ideas of the present application, there will be changes in specific implementations and applications. Above all, the content of the present specification should not be construed as a limitation to the present application.

1. A display device, comprising:
a substrate, wherein an upper surface of the substrate is provided with a concavo-convex;
a light-shielding layer disposed on the substrate;
a color filter layer disposed on the light-shielding layer; and
an array substrate disposed on the color filter layer.

2. The display device as claimed in claim 1, wherein a thickness of the concavo-convex accounts for 5% to 20% of a total thickness of the substrate.

3. The display device as claimed in claim 1, wherein a thickness of the substrate ranges from 1000 nanometers to 500000 nanometers.

4. The display device as claimed in claim 1, wherein a thickness of the light-shielding layer ranges from 100 nanometers to 1200 nanometers.

5. The display device as claimed in claim 1, wherein a roughness of the concave-convex structure ranges from 0.5 micrometer to 6 micrometer.

6. The display device as claimed in claim 1, wherein an area of the concavo-convex accounts for 0.5% to 6% of a total area of the substrate.

7. The display device as claimed in claim 1, further comprising a liquid crystal layer, wherein the liquid crystal layer is disposed between the color filter layer and the array substrate.

8. The display device as claimed in claim 7, further comprising a first conductive layer, wherein the first conductive layer is located at a side of the liquid crystal layer away from the array substrate.

9. The display device as claimed in claim 7, further comprising a second conductive layer, wherein the second conductive layer is located at a side of the liquid crystal layer close to the array substrate.

10. A display device, comprising:
a substrate, wherein an upper surface of which is provided with a concavo-convex;
a light-shielding layer disposed on the substrate; and
a color filter layer disposed on the light-shielding layer.

11. The display device as claimed in claim 10, wherein a thickness of the concavo-convex accounts for 5% to 20% of a total thickness of the substrate.

12. The display device as claimed in claim 10, wherein a thickness of the substrate ranges from 1000 nanometers to 500000 nanometers.

13. The display device as claimed in claim 10, wherein a thickness of the light-shielding layer ranges from 100 nanometers to 1200 nanometers.

14. The display device as claimed in claim 10, wherein a roughness of the concave-convex structure ranges from 0.5 micrometer to 6 micrometer.

15. The display device as claimed in claim 10, wherein an area of the concavo-convex accounts for 0.5% to 6% of a total area of the substrate.

16. A method for manufacturing a display device, comprising steps of:
providing a substrate;
forming a concave-convex structure on an upper surface of the substrate by processing the substrate;
forming a light-shielding layer on the substrate; and
forming a color filter layer on the light-shielding layer.

17. The method as claimed in claim 16, wherein the step of forming the concave-convex structure on the upper surface of the substrate by processing the substrate comprises:
polishing the substrate to form the concave-convex structure on the upper surface of the substrate.

18. The method as claimed in claim 16, wherein the step of forming the concave-convex structure on the upper surface of the substrate by processing the substrate comprises:
etching the substrate to form the concave-convex structure on the upper surface of the substrate.

19. The method as claimed in claim 17, wherein the substrate is polished through a laser polishing process, and energy used in the laser polishing process ranges from 4000 millijoules per square centimeter to 8000 millijoules per square centimeter.
